(19) United States
(12) Patent Application Publication
(10) Pub. No.: US 2006/0073321 A1
(43) Pub. Date: Apr. 6, 2006

(54) Molded flexible polyurethane foams with reduced flammability and superior durability

(76) Inventors: Bryan D. Kaushiva, Hurricane, WV (US); William E. Slack, Moundsville, WV (US)

Correspondence Address: BAYER MATERIAL SCIENCE LLC, 100 BAYER ROAD, PITTSBURGH, PA, 15205, US

(21) Appl. No.: 10/956,392

(22) Filed: Oct. 1, 2004

(51) Int. Cl. B32B 3/26; B32B 5/18

(52) U.S. Cl. 428/304.4; 521/155; 428/160

(57) ABSTRACT

The present invention provides a process for producing a flexible polyurethane foam achieving reduced flammability and maintaining durability is presented. These foams are prepared by reaction of a di- or polyisocyanate/polyisocyanurate blend with polyol component optionally in the presence of a catalyst, a blowing agent, additives and a cross-linking agent. The polyisocyanurate used in the blend is a novel composition.

### FIELD OF THE INVENTION

The present invention relates in general to polyurethane foams, and more specifically, to the cold-molded production of flexible foam by the reaction of a polyol component with a blend of components containing isocyanate groups including one or more di- or poly-isocyanate compounds and one or more novel polyisocyanurate compounds. These flexible foams exhibit a combination of reduced flammability and high durability.

### BACKGROUND OF THE INVENTION

The production of flexible polyurethane foams is a common commercial process with a broad array of consumer goods being derived from it. The specifics of a manufacturing line are partially determined by the complexity of the product design. The cushioning pad of an automobile seating assembly, for example, is sufficiently complex to require an in-mold production process for economical production. Some heat is required to achieve adequate curing at the mold surface, however, and this has led to the development of two molding technologies.

The older molding process is referred to as “hot-cure” because of the temperature range utilized. This process generally uses relatively low molecular weight polyols (approximately 3,000 Daltons). Variations of polyol functionality and molecular weight are used to adjust the physical properties of the foams as needed. To achieve a high quality foam surface, the reactive mixture is poured into a mold at about 40° C. To obtain reasonable cure near the surface, the mold is quickly cycled up to about 120° C. These foams are ready for demold after about 10-15 minutes. The mold is cooled again and prepared for another cycle. Due to high energy costs and other manufacturing inefficiencies, this type of processing has decreased in popularity in North America.

The more popular “cold-cure” process also uses a heated mold, but maintains the mold at about 65° C. without any cooling cycle. Variations on this process exist, but demold times typically range below five minutes. This higher rate-of-cure is mainly achieved through the use of higher molecular weight polyols (approximately 5,000 Daltons) with higher oxyethylene end-capping. Variations in polyol functionality and molecular weight are also used in cold-cure processing to achieve the requisite combination of foam processing characteristics and foam physical properties.

The cold-cure process is now dominant in North America. Technological improvements during the last thirty years have provided performance advantages in some foam grades and have also facilitated density reductions for other foam grades. Three factors combine to limit the lower end of the practical density range for molded flexible polyurethane foam. First, because the maximal firmness decreases as the density is decreased, the necessity of meeting a specified firmness does provide a limit to possible density reduction. A second limiting factor is foam quality. As the formulations are altered to make lower density foams, they are also altered to meet the specified foam firmness. The formulation variables that increase foam firmness at a specific density also often tend to degrade durability performance. Durability is meant to indicate performance in static durability measurements such as hysteresis loss during compression, permanent compression sets, and humid aged properties. A third limiting factor is the flammability of the foam. Polyurethane foams can be flammable and that potential hazard must be considered in product design.

US Government standard methods, such as MVSS-302, applied to automotive foams are useful for ensuring an acceptable level of combustibility. The increasing flammability of foams of decreasing density acts as an additional limit on density reduction. This is especially true as some flame retarding additives degrade durability properties. An additional consideration is the fact that some preferred flame retardants, such as some polybrominated diphenyl ethers, have been shown to be bio-accumulative and represent an unknown environmental risk.

One solution to reducing the intrinsic flammability of the polyurethane foam is to build isocyanurate structure into the macromolecule of the solid state. Of all the linkages that can be formed when isocyanates react, the isocyanurate is the most thermally stable. Unlike many of its potential derivatives, it is more thermally stable than either a urethane or a urea linkage. This remarkable stability reduces the combustibility of foams made with it. The outstanding relative stability of these groups was shown in “The Thermal Decomposition of Polyurethanes and Polyisocyanurates” (Fire and Materials (1981), 5 (4) 133-41). Discussions of these structures, their formation and application can be found in general texts such as the Polyurethane Handbook by Gunther Oertel (Carl Hanser Verlag, Munich 1985, pp. 9-10, 79-80, 94, 235-236, 400). When isocyanurate structures are incorporated into the polymer of the solid state, it is frequently observed that durability properties degrade. Common flexible polyurethane foams typically contain flame retarding additives rather than isocyanurates to make them safer for consumers.

There are a number of approaches to incorporating isocyanurates into a foam. The most direct is to add a trimerization catalyst to a foam formulation so that the isocyanurate moieties form in situ concurrent with the other foam reactions. A second approach is to form the isocyanurate first and add it into the foam formulation as additional reactive component. A third approach is to incorporate isocyanurate moieties into non-reactive molecules that are used as non-reactive additives to the foam formulation. A fourth approach is to manufacture a foam part and post-treat it with a spray that contains isocyanurate moieties. Such sprays could be coatings that cure either through chemical cure or due solely to solvent evaporation from a dispersion.

1. Simultaneous Formation

The trimerization of isocyanate groups by the catalysis of strong bases, typically alkali acetates or alkali formates, has been known since the nineteenth century (see Oertel pp. 9-10). The usage of such catalysts in foams has been practiced since the 1960's. When polyisocyanates are trimerized during foam formation, highly cross-linked and rigid structures develop. The resulting physical properties are more suited to rigid foams than to flexible foams, which are the subject of the present disclosure. The loss of flow and increase of friability in typical rigid foams has led to isocyanurates being used in carefully controlled concentrations and in combination with flame retarding additives (see Oertel, pp. 79-80, 235-236, 259-260). In practice, only a fraction of the available isocyanate groups are trimerized. The trimer content in these polyisocyanurate foams (PIR) is varied according to the level of flame retardancy required.

Although PIR foams have found wide use for rigid applications, the simultaneous formation approach has found very limited use in flexible foams. This is primarily due to the poor durability properties observed in flexible foams made in this fashion, although the approach has been shown to provide some benefits.

GB 1,389,932 and GB 1,390,231, both in the name of Hughes et al., disclose a straightforward application of PIR techniques in flexible foam. Common trimerization catalysts such as potassium acetate are used in combination with an excess of isocyanate in a specific foam formulation. This is said to provide high resilience, a smooth stress/strain curve, and good self-extinguishing properties. The Hughes et al. patents fail to discuss the poor durability properties that such a foam would exhibit. This is an early example of isocyanurate application to flexible foams based upon polyether polyols.

SU 760,687 discloses a similar approach in polyester slabstock foams. Foams of this type have limited applicability due to their lower hydrolytic stability.

EP 0,169,707, in the name of Kaneyoshi, describes the use of titanate esters to catalyze the formation of isocyanurate moieties. Flexible polyurethane foams are produced based upon polyether polyol. Advantages were shown for these foams in a Butler Chimney test. However, no comments were made about durability or about the tensile or tear strengths of the resulting foams. Kaneyoshi does mention separately making and using the trimer as a reactive component but makes no comment regarding the stability of those reactive components with respect to precipitation.

DE 3810650 A1 describes the use of a trimerization catalyst within a flexible foam formulation. This work, however, focused on foams based upon methylene diphenylene diisocyanate (MDI) whereas the previously mentioned art focused on foams largely based upon tolylene diisocyanate (TDI). The high concentration of isocyanurate rings in these foams makes them suitable for some applications, such as an engine compartment liner, however, they are not suitable for the stringent durability specifications of automotive seating.

A newer use of this first approach is for the recycling of polyurethane foams. WO 99/54370, for example, describes the manufacture of foams from polyurethane waste by the use of isocyanurate catalysts.

The above-detailed art describes the attempts to apply the first approach in isocyanurate use to polyurethane foams. None of the resultant foams would provide cushions that perform to the standards of modern automotive seating.

2. Additional Reactive Isocyanate Component

The second approach, that of synthesizing the isocyanurate separately, is complicated by the tendency of some isocyanurate compounds to precipitate out of solution. This complication has usually been surmounted by focusing on compositions that do not precipitate, which has somewhat limited the ability to develop optimal foam properties. Trimers made from pure MDI monomer (in a ratio of about 52 mol % 2,4′- and about 46 mol % 4,4′- and about 2 mol % 2,2-methlylene diphenlyene diisocyanate) can provide stable solutions (See, U.S. Pat. No. 5,124,370). However too few advantages are observed with the usage of these materials to justify the compromises in the higher compressions sets of the foams that result. Trimers made from pure TDI (in its common isomeric ratios) can provide somewhat stable solutions (See, U.S. Pat. No. 4,456,709 or DE 2063731), but these are not completely stable and tend to be problematic in use. Moreover, no physical property advantages justify their use. Trimers of surprising stability can be synthesized by co-trimerizing TDI blended with 4,4′-methylene diphenyl diisocyanate as described in U.S. Pat. No. 6,515,125. Producing trimers from allophanate-modified TDI also produces solutions of surprising stability (as described in U.S. Pat. Nos. 6,028,158 and 6,063,891).

Taub, in U.S. Pat. No. 3,856,718, utilized “isocyanurate polyol” to manufacture cold-cure high-resilience molded flexible polyurethane foam. It appears that the primary advantage of Taub lies in the reduction of aliphatic and aromatic diamines used in foams to provide cure. This reduction and increased polyol functionality provided benefits in compression sets and in humid aging properties. However, the archaic formulations of the examples given in Taub exhibit poor humid aged performance and low resiliency relative to modern seating standards. No benefits in combustion resistance were noted. Moreover, the compounds used as curing agents were various alkoxylates of tris(2-hydroxyalkyl)isocyanurate.

JP 50-128795 and JP 50-128795 both examine the use of very specific isocyanurate-containing compounds in which all residual reactive moieties are hydroxyl groups. These compounds are used as part of the polyol in the foam formulation. These compositions are said to provide a benefit in reducing the fuming of the foam in a smoke test but require additional flame-retarding additives to suppress combustion.

DE 2605713 describes the use of a trimer for the production of polyurethane foam with self-extinguishing character. The trimer used was based solely upon tolylene diisocyanate.

Snyder et al., in U.S. Pat. No. 4,552,903, disclose the use of alkylene-bridged polyphenylene polyisocyanates and review the use of all-TDI trimers in foams and note the poor physical properties that result. The foams of Snyder et al. are made from a polyol and an isocyanate solution containing prepolymers synthesized to contain isocyanurates in a three step process. In the first step, prepolymers are built on short chain diols using polyphenylene polyisocyanates. In the second step, the prepolymer and more polyphenylene polyisocyanate is trimerized into “cotrimer”. In a final step, the cotrimer was reacted with more polyol to form the final prepolymer which can be diluted as desired with other polyphenylene polyisocyanates. The resulting stable solution of an isocyanurate structure is used to form flexible polyurethane foams. The most preferred composition of Snyder et al. used TDI in the first prepolymer (with dipropylene glycol), followed by the addition of 4,4′-MDI for the cotrimer formation and the final prepolymerization used tripropylene glycol. This prepolymer was diluted with TDI for the preparation of the foams. The use of this narrow composition is said to provide some level of burn resistance, but this is not qualified with respect to foam density. It is shown that this trimer product increases the ratio of 65% IFD to density and maintains reasonable handling and durability properties. Snyder et al. specifically describe trimers built using alkylene-bridged polyphenylene polyisocyanates.

EP 0,884,340 A1, in the name of Cellarosi et al., examines the use of a narrow isocyanate composition for improved burn resistance in flexible foams. The composition of Cellarosi et al. was 20-30 wt. % TDI, 30-40% MDI (with 2,4′ isomer content of more than 40 wt. %), and 30-50 wt. % of oligomeric TDI. The preferred overall isocyanate blend contained 27.7% trimer and 11.8% tetrafunctional TDI oligomer. It is noted that the storage stability of this composition was not discussed. A similar composition to that of Cellarosi et al. was examined in Example 26 of U.S. Pat. No. 6,028,158 and was found to form precipitates on storage. It is also difficult from this example to determine whether the improvement in burn resistance occurs due to the isocyanate blend or because of the 18% increase in apparent foam density.

JP 2000-226429 discloses the use of aliphatic or alicyclic polyisocyanate trimers in foams with an advantage in improved resistance to NOx yellowing. It is not clear from this disclosure whether the light stability advantage derived from the use of the trimer or merely from the use of IPDI. However, the higher expense and lower reactivity of the aliphatic and alicyclic polyisocyanates in general make this invention less suited for automotive seating.

The above-referenced art describes the second approach in isocyanurate application, and to summarize, relatively few compositions have been applied and few of those have been shown to impart much of an advantage. It is particularly noted that only two of the disclosures describe advantages in combustibility resistance. It should be clear from this discussion that many compositions remain that may provide more optimal property combinations.

3. Non-Reactive Isocyanurate Additive

The third approach to incorporating isocyanurate moieties within the foam is by using isocyanurate compounds that are non-reactive as formulation additives. U.S. Pat. No. 5,182,310, for example, disclosed the use of phenolic antioxidants, including tris-(3,5-di-t-butyl-4-hydroxybenzyl)isocyanurate), at parts per million (ppm) levels for reducing scorch in foams. DE 2244543 describes the use of tris-(2,3-dibromopropyl)isocyanurate as a flame retarding additive. Two patents, DE 2836594 and DE 4003230 A1, describe the use of alkyl-substituted isocyanurates as flame retarding additives (the former in rigid foams and the latter in flexible). GB 1,267,011 and GB 1,337,659, both to von Gizycki et al., describe the use in flexible foams of solutions of isocyanurate rings in non-trimerized polyisocyanates, where the isocyanurates have been defunctionalized by reaction with low molecular weight hydric compounds. The foams of von Gizycki et al. are said to exhibit combustion resistance.

4. Post-Manufacture Isocyanurate Treatment

The fourth application approach is in coating the foam after it has been produced. JP 2002-145982 describes the use of isocyanurates in coatings of polyurethane foam sheets for the purpose of improving hardness. The intended use of the coating of that patent application is for automotive interior parts, but it is possible that a similar coating could be applied thinly to a seating cushion. The MVSS302 standard, mentioned herein above, allows for the inclusion of an “adhesive layer” above the foam such that a coating could be used to aid in achieving the regulatory standard. However, the addition of a unit operation at the end of a foam line would be cumbersome and expensive so that this approach would be disfavored.

Therefore, a need exists in the art for a way of ensuring combustibility performance at conventional densities without degrading properties and providing a way of reaching lower densities in less critical foam components.

### SUMMARY OF THE INVENTION

Accordingly, the present invention provides a way to meet flammability standards in flexible foams while maintaining high quality both in terms of comfort and durability by producing foams including novel polyisocyanurates, described as “MDI trimer allophanates” which contain in substantial part 2,2′-, 2,4′- and 4,4′-methylene diphenylene diisocyanates and an organic compound having at least one hydroxyl group. These components are reacted together to form an allophanate-modified isocyanurate, i.e., the MDI trimer allophanate. The foams of the present invention are preferably prepared by a one-shot process and are preferably water-blown.

The polyurethane foams of the present invention exhibit excellent burn resistance without any degradation of properties. Where the novel isocyanurate composition makes up a significant fraction of the isocyanate component in the manufacture of flexible polyurethane foams, it is surprisingly observed that the durability of the foam is maintained and the tensile, tear, and elongation properties are improved. The inventive foams are not limited by the mode of production, whether in a molded or continuous slabstock production mode or whether by a one-shot foaming methodology or by a prepolymer foaming technique. The advantages due to the novel isocyanurate are observed in flexible foam because of its incorporation in the formulation and not because of the foam processing technique used. The foams of the present invention further exhibit improved handling characteristics while having self-extinguishing properties.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The flexible polyurethane foams of the present invention are the reaction product of an isocyanate component containing about 0.5 wt. % to about 40 wt. %, based on the weight of the isocyanate component, of at least one methylenediphenylene diisocyanate (MDI) trimer allophanate, and at least one di- or polyisocyanate, with a polyol component, optionally in the presence of one or more components chosen from catalysts, additives, surfactants, fillers, cross-linkers and blowing agents. The flexible polyurethane foam of the present invention has fire retarding properties.

The present invention further provides a process of making polyurethane foam involving reacting in a mold which is at about 65° C. an isocyanate component containing about 0.5 wt. % to about 40 wt. %, based on the weight of the isocyanate component, of at least one methylenediphenylene diisocyanate (MDI) trimer allophanate, and at least one di- or polyisocyanate, with a polyol component optionally in the presence of one or more components chosen from catalysts, additives, surfactants, fillers, cross-linkers and blowing agents, wherein the flexible polyurethane foam has fire retarding properties.

The present invention yet further provides an improved process for decreasing the combustibility of a polyurethane foam, the improvement involving reacting in a mold which is at about 65° C. an isocyanate component containing about 0.5 wt. % to about 40 wt. %, based on the weight of the isocyanate component, of at least one methylenediphenylene diisocyanate (MDI) trimer allophanate, and at least one di- or polyisocyanate, with a polyol component, optionally, in the presence of one or more components chosen from catalysts, additives, surfactants, fillers, cross-linkers and blowing agents, wherein the flexible polyurethane foam has fire retarding properties.

Based on their experience with MDI trimers, the inventors herein have found a type of trimer to provide a surprising combination of good performance characteristics. This trimer type is described in detail in assignee's co-pending U.S. patent application Ser. No. 10/706,713, the entire contents of which are incorporated herein by reference thereto. This trimer is described as the trimerization product of an allophanate-modified mixture of 2,2′-, 2,4′-, and 4,4′-methylene diphenyl diisocyanate isomers. As is apparent to one skilled in the art, any of the compositions of co-pending U.S. application Ser. No. 10/706,713 would be useful in the present invention. A most particularly preferred composition in the foams of the present invention was synthesized in two reactive steps as follows. In the first step, allophanate is formed during a 30 minute reaction by holding at 90° C. the following blend:
96.14 wt. % of an isomeric blend of
   0.7 wt. % 2,2′-methylene diphenyl diisocyanate,
   21.6 wt. % 2,4′-methylene diphenyl diisocyanate, and
   77.7 wt. % 4,4′-methylene diphenyl diisocyanate;
3.85 wt. % of isobutanol, and
0.01 wt. % of zinc acetyl acetonate (allophanate catalyst).
   In the second step, 0.02 wt. % of DD1547 (a trimerization catalyst, the Mannich base methylene-bis(3,3′-5,5′-tetradimethylaminomethyl-2,2′-phenol) where the percentage is based on the final mixture) is added and the mixture is allowed to trimerize for 90 minutes. This provided a 26.1% FNCO mixture with a viscosity of 190 CP.

It is most preferred that the isocyanurate of the type described above makes up a significant fraction (above 0.5 wt. %) of the isocyanate of the foam formulation. The novel isocyanurate can be used neat or as admixtures with unmodified isocyanates. It is preferred to use the isocyanurate compound in an admixture in which it makes up preferably from 0.5 wt. % and 40 wt. %, more preferably from 10 wt. % and 30 wt. %, and most preferably 20 wt. %. The rest of the isocyanate component may contain one or more di- or poly-isocyanates or modified isocyanates. One non-limiting, and particularly preferred, example of a suitable di-isocyanate includes 2,4- and 2,6-toluene diisocyanates (TDI), as a mixture of these isomers. Another non-limiting example of a suitable di-isocyanate includes 2,2′-, 2,4′-, and 4,4′-methylenediphenylene diisocyanates (MDI), preferably as mixture containing the 4,4′-isomer in major part. Such admixtures of the isomers of methylenediphenylene may also contain some polymeric MDI preferably from 0 to 55 wt. %, more preferably between 0 and 30 wt. %, and most preferably from 0 to 10 wt. %. A non-limiting example of a suitable poly-isocyanate is polymethylene polyphenylene polyisocyanates prepared by the phosgenation of mixtures predominately two to five ring condensation products of formaldehyde and aniline. Mixtures of such isocyanates are suitable and known to those skilled in the art.

Modified isocyanates are also well-known those skilled in the art, and these include urea-, urethane-, carbodiimide-, allophanate-, uretonimine-, other isocyanurate-, uretdione-, and other modified isocyanates. Such isocyanates are prepared by reaction of a stoichiometric excess of isocyanate with an isocyanate reactive compound. To form urethane-modified isocyanates, for example, a monomeric or oligomeric glycol could be utilized. Urea-modified isocyanates can be formed by use of compounds such as water or a diamine. Other modifications may be obtained by the reaction of isocyanates pure or in mixtures with themselves via dimerization or trimerization. Urethane- and carbodiimide-modified isocyanates are preferred.

In addition to the novel isocyanurate, the isocyanate component most preferably includes TDI, MDI, or a mixture of TDI and MDI, where the MDI can encompass purely monomeric or polymeric forms. As known to those skilled in the art, the isocyanate index is calculated by multiplying 100 by the ratio of isocyanate groups to all active hydrogen groups contained in the polyol component, the water, the cross-linkers, etc. An isocyanate 100 index thus represents a stoichiometric ratio. The isocyanate component is supplied in an amount effective to provide an isocyanate index preferably from 70 to 120, more preferably from 90 to 110, and most preferably from 95 to 105.

The polyol component may preferably be a blend of one or more polyoxyalkylene polyols made by any of the various well-known synthetic methods, such as production utilizing common basic catalysis or double metal cyanide complex (“DMC”) catalysis. The polyol component may additionally include polymer polyol or polymer-modified polyol such as dispersions of vinyl polymers or non-vinyl solids within a polyol matrix. Where such “filled” polyols are utilized, the polyol carrier weight exclusive of the filler is calculated as part of the total polyol weight. Nominal initiator functionality for the polyols are preferably from 2 to 8 or more, more preferably from 2 to 6, and most preferably from 2 to 4. For ease of manufacture, it is preferable that the resulting blend of polyols exhibit a primary hydroxyl content of not less than 65%, but more preferably greater than 70%, and most preferably greater than 80%. The polyol component, by weight, may further contain polyoxyalkylene polyols having equivalent weights in excess of 700 Da, preferably in the range of 1,500 Da to 7,000 Da, and more preferably in the range of 1,500 Da to 3,000 Da.

As mentioned above, the polyol component may contain one or more polymer polyols or polymer-modified polyols both of which are often referred to as reinforcing fillers. Polymer polyols are dispersions of vinyl polymer within a polyoxyalkylene base polyol such as dispersions of styrene/acrylonitrile random copolymers. Polymer-modified polyols are dispersions of non-vinyl solids. These non-vinyl solids are isocyanate-derived solids such as PIPA and PHD polyols within a polyoxyalkylene base polyol carrier. Both polymer polyols and polymer-modified polyols are well-known to those skilled in the art.

Chain extenders and/or cross-linkers may be included and their usage is well-known to those skilled in the art. Chain extenders include hydroxyl and amine functional molecules with nominal functionalities of two, where a primary amine group is considered to be monofunctional, and they have a molecular weight of less than 500 Da. Some non-limiting examples of chain extenders include ethylene glycol, diethylene glycol, propylene glycol, dipropylene glycol, tripropylene glycol, monoethanolamine, toluene diamine, and the various electronically and sterically hindered aromatic amines such as ar-alkylated toluene diamines and methylenedianilines and substituted aromatic amines such as 4,4′-methylenebis(orthochloroaniline) or “MOCA”. Preferred chain extenders include aliphatic glycols and mono- or di-alkanolamines.

Cross-linkers contain a nominal functionality greater than three and have molecular weights less than 500 Da. Non-limiting examples of these include glycerin, triethanolamine, and diethanolamine. Diethanolamine or “DEOA” is preferred. Chain extenders and cross-linkers are used in the invention in conventional amounts, such as less than 5 parts based on 100 parts of the polyol component.

One or more foam stabilizing surfactants may be included and suitable surfactants are well-known to those skilled in the art. Suitable surfactants are available from companies such as Air Products, Goldschmidt A.G., and GE Plastics (formerly Crompton).

One or more blowing agents may be included to form the foams of the invention and these may be of the physical or reactive type. Non-limiting examples of physical blowing agents include lower alkanes, hydrofluorocarbons, perfluorocarbons, chlorofluorocarbons and the like. Environmental considerations make the usage of many potentially useful physical blowing agents, such as the chlorofluorocarbons, disfavored. More preferred blowing agents are liquid carbon dioxide as a physical blowing agent and/or water as a non-limiting example of a reactive blowing agent. The carbon dioxide may be added to the reaction mixture in the foam mix head in liquid form. Mixtures of reactive or physical blowing agents may be utilized, for example water and one or more lower alkanes or water and carbon dioxide. Water is the most preferred blowing agent, in amounts preferably from 1 to 7 parts by weight relative to 100 parts of the polyol component, more preferably from 1.7 to 5.5 parts, and most preferably from 2 to 4.5 parts.

One or more catalysts may be included. Metal catalysts, such as tin compounds, may be utilized in combination with amine-type catalysts, but it has been found that foams of the subject invention may be prepared in the absence of such metal catalysts while still obtaining demold times of five minutes or less. Suitable metal catalysts are known to those skilled in the art. Preferred metal catalysts include stannous octoate, dibutyltin dilaurate, and dibutyltin diacetate. It is preferred, however, to use one or more amine-type catalysts. Suitable amine-type catalysts are known to those skilled in the art and non-limiting examples include bis(2-dimethylaminoethyl)ether and triethylene diamine.

### EXAMPLES

The present invention is further illustrated, but is not to be limited, by the following examples. All quantities given in “parts” and “percents” are understood to be by weight, unless otherwise indicated.

### Example 1 and Comparative Examples C-2 to C-9

To best illustrate the reduction on combustibility of flexible polyurethane foams, the high water formulation shown in Table I was used for these examples. The foams were made to a 100 mm thickness at 24 kg/m³ apparent density by mixing the components using a high speed drill press mixer and by pouring the reactive mix into a heated aluminum box mold. The mold temperature was 150° F. (65° C.) and the demold time was five minutes.

TABLE I

| Component | Parts | Description |
|---|---|---|
| base polyol | 76.5 | 5,000 MW triol with 16% oxyethylene cap |
| polymer polyol | 23.5 | 10% solids content |
| water | 6.25 | chemical blowing agent |
| diethanolamine | 1.0 | cross-linking agent |
| DABCO DC | 1.0 | silicone surfactant |
| 5164 | | |
| NIAX A-1 | 0.08 | amine catalyst |
| NIAX A-33 | 0.32 | amine catalyst |
| TDI/Table II | 100 | stoichiometric amount of blend of 80% TDI |
| isocyanate | index | with 20% of a Table 2 isocyanate |

Table II provides a list of isocyanate components used in making foams in the examples.

TABLE II

| Isocyanate | Description |
|---|---|
| E-1 | MDI trimer allophanate |
| C-2 | MDI trimer |
| C-3 | TDI |
| C-4 | polymeric MDI blend |
| C-5 | monomeric MDI isomer blend |
| C-6 | TDI with 5 parts of FYROL FR2 |
| C-7 | cotrimer |
| C-8 | TDI/MDI mixed trimer |
| C-9 | MDI allophanate |

A more detailed description of each of the isocyanate components listed in Table II is provided below:
E-1 an “MDI Trimer Allophanate” was produced by the two step process described hereinabove. In the first step, allophanate was formed during a 30 minute reaction by holding at 90° C. the following blend: about 96.14 wt. % of an isomeric blend of methylene diphenyl diisocyanate (about 0.7 wt. % 2,2′-, about 21.6 wt. % 2,4′-, and about 77.7 wt. % 4,4′-); about 3.85 wt. % of isobutanol, and about 0.01 wt. % of zinc acetyl acetonate. In the second step, about 0.02 wt. % of DD1547 (the Mannich base methylene-bis(3,3′-5,5′-tetradimethylaminomethyl-2,2′-phenol) where the percentage is based on the final mixture) was added and the mixture was allowed to trimerize for about 90 minutes. This provided a 26.1% FNCO mixture with a viscosity of 190 CP.
C-2 an “MDI Trimer” made according to Example 7 of U.S. Pat. No. 5,124,370, leading to the product of 28.0% FNCO, 330 CP at 25° C. and containing 33.6 wt. % trimer. This product was then blended with other MDI isomers to provide the characteristics shown in Table 3.
C-3 a common commercial blend of toluene diisocyanate isomers: 80% by weight of the 2,4 isomer and 20% by weight of the 2,6 isomer.
C-4 an MDI blend containing some polymeric MDI. This product contained about 53-57% polymeric MDI and about 43-47% monomeric MDI. Such products are sometimes used to impart a level of flame retardancy.
C-5 a high monomeric MDI blend containing about 75-81% monomer and about 19-25% polymeric MDI.
C-6 pure TDI except that the foam made with this isocyanate also included 5 parts of a common flame retardant in the polyol resin mixture.
C-7 a “cotrimer of alkylene-bridged polyphenylene polyisocyanates” made according to Example 1 of U.S. Pat. No. 4,552,903.
C-8 made by a similar two step process to Example 1 above, except that the isocyanate blend in this case had 60 wt. % of 4,4′ MDI mixed with 40 wt. % TDI.
C-9 made according to the first step of Example 1 above, so that it contained only allophanate linkages without any trimer content.

In Table III below, firmness was characterized according to Test B₁ of ASTM D 3574-95.

Hysteresis was measured by the following method. Using a deflector foot of eight-inch diameter and a deflection rate of two inches per minute, foams were deflected to 75% of their original height. These deflection cycles were repeated three times with a one-minute rest period between each cycle. Using the load-deflection data from the third cycle, the area between the loading and the unloading curve was calculated as a percentage of the loading curve. This provides an estimate of the hysteresis loss.

50% and 75% compression set tests were conducted according to Test D of ASTM D 3574-95.

Humid aged load loss (HALL) was characterized according to Test J₁ of ASTM D 3574-95, where the load was measured by Test C with the exception that the mechanically convected dry air oven was maintained at 70° C. instead of 100° C.

Humid aged (HA) compression sets were tested at 50% deflection by humid aging the 2×2×1 in³ samples according to Test J₁ of ASTM D 3574-95. Following the humid aging, the samples were dried at 70° C. for three hours, held at ASTM lab conditions overnight, and initial thicknesses were measured. The samples were compressed in the plates and held again at 70° C. for 22 hours. Final thickness measurements were collected following a 30 minute recovery at ASTM laboratory conditions.

Finally, a “wet compression set” test was collected at 50% deflection, in which the 2×2×1 in³ samples were held compressed for 22 hours at 50° C. and 98% relative humidity and post-compression thickness measurements were collected following a 30 minute recovery at ASTM laboratory conditions.

Taken together, the above-detailed tests are useful in predicting the durability of the foam. Additional aspects of quality include comfort and vibrational transmissivity of the foam part.

TABLE III

| | E-1 | C-2 | C-3 | C-4 | C-5 | C-6 | C-7 | C-8 | C-9 |
|---|---|---|---|---|---|---|---|---|---|
| Trimer content | 2.7 | 2.5 | 0 | 0 | 0 | 0 | 3.6 | 2.7 | 0 |
| 4,4′-MDI content | 15.0 | 14.4 | 0 | 8.2 | 11.4 | 0 | 0.03 | 16.1 | 16.0 |
| 2,4′-MDI content | 4.2 | 5.4 | 0 | 0.7 | 4.1 | 0 | 0 | 3.6 | 3.9 |
| 2,2′-MDI content | 0.1 | 0.2 | 0 | 0 | 0.1 | 0 | 0 | 0.1 | 0.1 |
| polymeric MDI | 0 | 0 | 0 | 11.0 | 4.4 | 0 | 0 | 0 | 0 |
| allophanate | yes | no | no | no | no | no | no | no | yes |
| core density (lbs/ft³) | 1.32 | 1.55 | 1.40 | 1.44 | 1.37 | 1.52 | 1.28 | 1.34 | 1.41 |
| resiliency (%) | 52 | 56 | 61 | 49 | 58 | 55 | 58 | 60 | 57 |
| air flow (scfm/2 × 2 × 1 in.) | 2.00 | 1.40 | 2.90 | 4.76 | 2.34 | 2.39 | 1.94 | 1.71 | 1.62 |
| 20% IFD (lbs) | 21.6 | 22.5 | 20.0 | 19.5 | 24.6 | 26.3 | 22.3 | 24.5 | 27.7 |
| 50% IFD (lbs) | 42.5 | 44.7 | 38.4 | 41.0 | 49.3 | 48.9 | 42.6 | 47.1 | 53.9 |
| 65% IFD (lbs) | 67.5 | 70.1 | 60.3 | 68.2 | 78.8 | 76.6 | 66.1 | 73.2 | 85.6 |
| 65/25 load ratio | 3.13 | 3.11 | 3.01 | 3.51 | 15.81 | 2.91 | 2.97 | 2.99 | 3.09 |
| 50% CFD (psi) | 0.19 | 0.21 | 0.16 | 0.17 | 0.17 | 0.28 | 0.18 | 0.21 | 0.24 |
| ASTM tensile (psi) | 14.9 | 15.9 | 12.8 | 11.3 | 13.8 | 14.7 | 13.3 | 14.8 | 13.5 |
| ASTM elongation (%) | 88 | 80 | 79 | 73 | 77 | 74 | 83 | 88 | 77 |
| ASTM tear (lb/in) | 1.40 | 1.20 | 0.8 | 0.9 | 1.2 | 1.6 | 1.39 | 1.48 | 1 |
| 50% compression set (%) | 18.5 | 19.4 | 11.1 | 17.1 | 19.6 | 33.3 | 15.2 | 15.7 | 21.0 |
| 50% HALL (%) | −1.8 | −7.9 | 6.3 | 5.8 | — | 9.8 | −1.4 | 1.6 | 15.3 |
| 50% HA comp set (%) | 37.5 | 32.5 | 21.0 | 32.5 | 34.2 | 28.7 | 34.6 | 36.0 | 39.9 |
| 50% wet comp set (%) | 38.2 | 42.0 | 28.9 | 31.6 | 33.7 | 32.8 | 42.3 | 40.3 | 35.0 |
| SAE J369 | SE/NBR | SE | B | B | B | B | B | SE/B | B |
| burn rate (mm/min.) | 0 | 0 | 131 | 122 | 141 | 113 | 118 | 115 | 158.5 |
| number out of 9 samples | 3 | 0 | 9 | 9 | 7 | 9 | 9 | 3 | 5 |
| burning past 25 mm | | | | | | | | | |
| number out of 9 samples | 0 | 0 | 9 | 8 | 6 | 8 | 9 | 1 | 5 |
| burning past 51 mm | | | | | | | | | |

SE = self-extinguishing
B = burns
NBR = no burn rate

For every example and comparative example, nine samples were tested according to the MVSS-302 method. The SAE J369 descriptors were used to provide further clarification.

The high amount of flame retardancy exhibited by foams of the present invention is apparent by reference to Table III. Of all the foams, only those made with E-1 and C-1 passed with SE (self-extinguishing) ratings. In neither case was a burn rate measurable because the 51 mm mark was not reached. All of the other foams failed this burn measurement due to high burn rate. Moreover, the compositions of the comparative examples make it clear that this retardancy is imparted by the MDI trimers of which E-1 and C-1 are non-limiting examples.

Beyond low combustibility, the foam physical properties demonstrate the value of the present invention. These are extremely low density foams, but the superiority of foam made from E-1 is immediately apparent to those skilled in the art. E-1 containing foams exhibit higher IFD measurements than foams made with C-2 or C-3. E-1 containing foams also exhibit high tensile, tear, and elongation measurements. Finally, the compression set and the humid aged properties are similar to those expected of TDI/MDI blends such as foams made with C-3. This demonstrates that the novel MDI allophanate trimers used in the foams of the present invention do not degrade foam physical properties.

Isocyanates E-1 and C-1 differ most distinctly in foam processing characteristics. This is best shown by the air flow measurements of Table III. The foams made with E-1 are remarkably open and flow very well in the mold. In free rise testing, these foams attain higher rises with less settleback and less shrinkage. This leads to a wider processing latitude with E-1 than with C-1. The lower air flow and higher density of foams made with C-1 are indicative of a low level of shrinkage that occurred before the foam was fully crushed open.

As the examples demonstrate, molded flexible polyurethane foams produced according to the present invention exhibit excellent burn resistance, good durability and improved handling characteristcs. Such foams are useful in applications where dampening is desirable, and some nonlimiting examples of such applications include automobile seating, railroad vehicles, boating applications, agricultural equipment, etc.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A flexible polyurethane foam comprising the reaction product of:
an isocyanate component comprising
about 0.5 wt. % to about 40 wt. %, based on the weight of the isocyanate component, of at least one methylenediphenylene diisocyanate (MDI) trimer allophanate, and
at least one di- or polyisocyanate,
with
a polyol component, and
optionally in the presence of one or more components chosen from catalysts, additives, surfactants, fillers, cross-linkers and blowing agents,
wherein the flexible polyurethane foam has fire retarding properties.

2. The flexible polyurethane foam according to claim 1, wherein the at least one methylenediphenylene diisocyanate (MDI) trimer allophanate comprises from about 10 wt. % to about 30 wt. % of the isocyanate component.

3. The flexible polyurethane foam according to claim 1, wherein the at least one methylenediphenylene diisocyanate (MDI) trimer allophanate comprises about 20 wt. % of the isocyanate component.

4. The flexible polyurethane foam according to claim 1, wherein the at least one methylenediphenylene diisocyanate (MDI) trimer allophanate comprises the reaction product of:
a) a diphenylmethane diisocyanate comprising
(i) from about 10 to about 40% by weight of 2,4′-diphenylmethane diisocyanate,
(ii) from 0 to about 6% by weight of 2,2′-diphenylmethane diisocyanate,
(iii) from about 54 to about 90% by weight of 4,4′-diphenylmethane diisocyanate, and
(iv) from about 0 to about 55% by weight of polymethylene polyphenylene polyisocyanate,
wherein the percentages by weight of a)(i), a)(ii), a)(iii) and a)(iv) total 100% by weight of a); and
b) an organic compound containing at least one hydroxyl group, in the presence of a catalytic amount of
c) at least one catalyst chosen from (1) one or more trimer catalysts, (2) one or more allophanate catalysts, (3) an allophanate-trimer catalyst system and (4) mixtures thereof;
wherein component b) is present in a quantity such that there are from about 0.01 to about 0.25 equivalent hydroxyl groups per equivalent of isocyanate of the MDI present, at least about 50% of the urethane groups are converted to allophanate groups by c) said catalyst or catalyst system, and a catalyst stopper is added once the desired NCO group content is attained.

5. The flexible polyurethane foam according to claim 4, wherein the diphenylmethane diisocyanate comprises about 21.6 wt. % of 2,4′-diphenylmethane diisocyanate, about 0.7 wt. % of 2,2′-diphenylmethane diisocyanate and about 77.7 wt. % of 4,4′-diphenylmethane diisocyanate and the organic compound containing at least one hydroxyl group is isobutanol.

6. The flexible polyurethane foam according to claim 1, wherein the at least one di- or polyisocyanate is chosen from 2,4- and 2,6-toluene diisocyanates, 2,2′-, 2,4′-, and 4,4′-methylenediphenylene diisocyanates, polymethylene polyphenylene polyisocyanates and urea-modified isocyanates, urethane-modified isocyanates, carbodiimide-modified isocyanates, allophanate-modified isocyanates, uretonimine-modified isocyanates, isocyanurate-modified isocyanates and uretdione-modified isocyanates.

7. The flexible polyurethane foam according to claim 1, wherein the at least one di- or polyisocyanate is chosen from toluene diisocyanate (TDI), methylenediphenylene diisocyanate (MDI) and a mixture of TDI and MDI.

8. The flexible polyurethane foam according to claim 1, wherein the polyol component comprises one or more polyoxyalkylene polyols.

9. The flexible polyurethane foam according to claim 1, wherein the polyol component includes one or more polymer polyols and/or polymer-modified polyols.

10. The flexible polyurethane foam according to claim 1, wherein the polyol component comprises a blend of polyols having a primary hydroxyl content of greater than about 65%.

11. The flexible polyurethane foam according to claim 1, wherein the polyol component comprises a blend of polyols having a primary hydroxyl content of greater than about 70%.

12. The flexible polyurethane foam according to claim 1, wherein the polyol component comprises a blend of polyols having a primary hydroxyl content of greater than about 80%.

13. The flexible polyurethane foam according to claim 1, wherein the chain extender is chosen from ethylene glycol, diethylene glycol, propylene glycol, dipropylene glycol, tripropylene glycol, monoethanolamine, toluene diamine, ar-alkylated toluene diamines, methylenedianilines and substituted aromatic amines.

14. The flexible polyurethane foam according to claim 1, wherein the chain extender is chosen from aliphatic glycols and mono- or di-alkanolamines.

15. The flexible polyurethane foam according to claim 1, wherein the cross-linking agent is chosen from glycerin, triethanolamine and diethanolamine.

16. The flexible polyurethane foam according to claim 1, wherein the blowing agent is chosen from lower alkanes, hydrofluorocarbons, perfluorocarbons and chlorofluorocarbons.

17. The flexible polyurethane foam according to claim 1, wherein the blowing agent comprises liquid carbon dioxide and water.

18. The flexible polyurethane foam according to claim 1, wherein the catalyst is chosen from stannous octoate, dibutyltin dilaurate, dibutyltin diacetate bis(2-dimethylaminoethyl)ether, triethylene diamine and mixtures thereof.

19. The flexible polyurethane foam according to claim 1, wherein the foam is self-extinguishing.

20. An automobile seat cushion comprising the flexible polyurethane foam according to claim 1.

21. A process of making polyurethane foam comprising reacting in a mold which is at about 65° C.:
an isocyanate component comprising
about 0.5 wt. % to about 40 wt. %, based on the weight of the isocyanate component, of at least one methylenediphenylene diisocyanate (MDI) trimer allophanate, and
at least one di- or polyisocyanate,
with
a polyol component, and
optionally in the presence of one or more components chosen from catalysts, additives, surfactants, fillers, cross-linkers and blowing agents,
wherein the flexible polyurethane foam has fire retarding properties.

22. The process according to claim 21, wherein the at least one methylene-diphenylene diisocyanate (MDI) trimer allophanate comprises from about 10 wt. % to about 30 wt. % of the isocyanate component.

23. The process according to claim 21, wherein the at least one methylene-diphenylene diisocyanate (MDI) trimer allophanate comprises about 20 wt. % of the isocyanate component.

24. The process according to claim 21, wherein the at least one methylene-diphenylene diisocyanate (MDI) trimer allophanate comprises the reaction product of:
a) a diphenylmethane diisocyanate comprising
(i) from about 10 to about 40% by weight of 2,4′-diphenylmethane diisocyanate,
(ii) from 0 to about 6% by weight of 2,2′-diphenylmethane diisocyanate,
(iii) from about 54 to about 90% by weight of 4,4′-diphenylmethane diisocyanate, and
(iv) from about 0 to about 55% by weight of polymethylene polyphenylene polyisocyanate,
wherein the percentages by weight of a)(i), a)(ii), a)(iii) and a)(iv) total 100% by weight of a); and
b) an organic compound containing at least one hydroxyl group, in the presence of a catalytic amount of
c) at least one catalyst chosen from (1) one or more trimer catalysts, (2) one or more allophanate catalysts, (3) an allophanate-trimer catalyst system and (4) mixtures thereof;
wherein component b) is present in a quantity such that there are from about 0.01 to about 0.25 equivalent hydroxyl groups per equivalent of isocyanate of the MDI present, at least about 50% of the urethane groups are converted to allophanate groups by c) said catalyst or catalyst system, and a catalyst stopper is added once the desired NCO group content is attained.

25. The process according to claim 24, wherein the diphenylmethane diisocyanate comprises about 21.6 wt. % of 2,4′-diphenylmethane diisocyanate, about 0.7 wt. % of 2,2′-diphenylmethane diisocyanate and about 77.7 wt. % of 4,4′-diphenylmethane diisocyanate and the organic compound containing at least one hydroxyl group is isobutanol.

26. The process according to claim 21, wherein the at least one di- or polyisocyanate is chosen from 2,4- and 2,6-toluene diisocyanates, 2,2′-, 2,4′-, and 4,4′-methylenediphenylene diisocyanates, polymethylene polyphenylene polyisocyanates and urea-modified isocyanates, urethane-modified isocyanates, carbodiimide-modified isocyanates, allophanate-modified isocyanates, uretonimine-modified isocyanates, isocyanurate-modified isocyanates and uretdione-modified isocyanates.

27. The process according to claim 21, wherein the at least one di- or polyisocyanate is chosen from toluene diisocyanate (TDI), methylenediphenylene diisocyanate (MDI) and a mixture of TDI and MDI.

28. The process according to claim 21, wherein the polyol component comprises one or more polyoxyalkylene polyols.

29. The process according to claim 21, wherein the polyol component includes one or more polymer polyols and/or polymer-modified polyols.

30. The process according to claim 21, wherein the polyol component comprises a blend of polyols having a primary hydroxyl content of greater than about 65%.

31. The process according to claim 21, wherein the polyol component comprises a blend of polyols having a primary hydroxyl content of greater than about 70%.

32. The process according to claim 21, wherein the polyol component comprises a blend of polyols having a primary hydroxyl content of greater than about 80%.

33. The process according to claim 21, wherein the chain extender is chosen from ethylene glycol, diethylene glycol, propylene glycol, dipropylene glycol, tripropylene glycol, monoethanolamine, toluene diamine, ar-alkylated toluene diamines, methylenedianilines and substituted aromatic amines.

34. The process according to claim 21, wherein the chain extender is chosen from aliphatic glycols and mono- or di-alkanolamines.

35. The process according to claim 21, wherein the cross-linking agent is chosen from glycerin, triethanolamine and diethanolamine.

36. The process according to claim 21, wherein the blowing agent is chosen from lower alkanes, hydrofluorocarbons, perfluorocarbons and chlorofluorocarbons.

37. The process according to claim 21, wherein the blowing agent comprises liquid carbon dioxide and water.

38. The process according to claim 21, wherein the catalyst is chosen from stannous octoate, dibutyltin dilaurate, dibutyltin diacetate bis(2-dimethyl-aminoethyl)ether, triethylene diamine and mixtures thereof.

39. An automobile seat cushion comprising the flexible polyurethane foam made by the process according to claim 21.

40. In a process for decreasing the combustibility of a polyurethane foam, the improvement comprising reacting at about 65° C.:
an isocyanate component comprising
about 0.5 wt. % to about 40 wt. %, based on the weight of the isocyanate component, of at least one methylenediphenylene diisocyanate (MDI) trimer allophanate, and
at least one di- or polyisocyanate,
with
a polyol component,
optionally, in the presence of one or more components chosen from catalysts, additives, surfactants, fillers, cross-linkers and blowing agents,
wherein the flexible polyurethane foam has fire retarding properties.

41. The process according to claim 40, wherein the at least one methylene-diphenylene diisocyanate (MDI) trimer allophanate comprises from about 10 wt. % to about 30 wt. % of the isocyanate component.

42. The process according to claim 40, wherein the at least one methylene-diphenylene diisocyanate (MDI) trimer allophanate comprises about 20 wt. % of the isocyanate component.

43. The process according to claim 40, wherein the at least one methylene-diphenylene diisocyanate (MDI) trimer allophanate comprises the reaction product of:
a) a diphenylmethane diisocyanate comprising
(i) from about 10 to about 40% by weight of 2,4′-diphenylmethane diisocyanate,
(ii) from 0 to about 6% by weight of 2,2′-diphenylmethane diisocyanate,
(iii) from about 54 to about 90% by weight of 4,4′-diphenylmethane diisocyanate, and
(iv) from about 0 to about 55% by weight of polymethylene polyphenylene polyisocyanate,
wherein the percentages by weight of a)(i), a)(ii), a)(iii) and a)(iv) total 100% by weight of a); and
b) an organic compound containing at least one hydroxyl group, in the presence of a catalytic amount of
C) at least one catalyst chosen from (1) one or more trimer catalysts, (2) one or more allophanate catalysts, (3) an allophanate-trimer catalyst system and (4) mixtures thereof;
wherein component b) is present in a quantity such that there are from about 0.01 to about 0.25 equivalent hydroxyl groups per equivalent of isocyanate of the MDI present, at least about 50% of the urethane groups are converted to allophanate groups by c) said catalyst or catalyst system, and a catalyst stopper is added once the desired NCO group content is attained.

44. The process according to claim 43, wherein the diphenylmethane diisocyanate comprises about 21.6 wt. % of 2,4′-diphenylmethane diisocyanate, about 0.7 wt. % of 2,2′-diphenylmethane diisocyanate and about 77.7 wt. % of 4,4′-diphenylmethane diisocyanate and the organic compound containing at least one hydroxyl group is isobutanol.

45. The process according to claim 40, wherein the at least one di- or polyisocyanate is chosen from 2,4- and 2,6-toluene diisocyanates, 2,2′-, 2,4′-, and 4,4′-methylenediphenylene diisocyanates, polymethylene polyphenylene polyisocyanates and urea-modified isocyanates, urethane-modified isocyanates, carbodiimide-modified isocyanates, allophanate-modified isocyanates, uretonimine-modified isocyanates, isocyanurate-modified isocyanates and uretdione-modified isocyanates.

46. The process according to claim 40, wherein the at least one di- or polyisocyanate is chosen from toluene diisocyanate (TDI), methylenediphenylene diisocyanate (MDI) and a mixture of TDI and MDI.

47. The process according to claim 40, wherein the polyol component comprises one or more polyoxyalkylene polyols.

48. The process according to claim 40, wherein the polyol component includes one or more polymer polyols and/or polymer-modified polyols.

49. The process according to claim 40, wherein the polyol component comprises a blend of polyols having a primary hydroxyl content of greater than about 65%.

50. The process according to claim 40, wherein the polyol component comprises a blend of polyols having a primary hydroxyl content of greater than about 70%.

51. The process according to claim 40, wherein the polyol component comprises a blend of polyols having a primary hydroxyl content of greater than about 80%.

52. The process according to claim 40, wherein the chain extender is chosen from ethylene glycol, diethylene glycol, propylene glycol, dipropylene glycol, tripropylene glycol, monoethanolamine, toluene diamine, ar-alkylated toluene diamines, methylenedianilines and substituted aromatic amines.

53. The process according to claim 40, wherein the chain extender is chosen from aliphatic glycols and mono- or di-alkanolamines.

54. The process according to claim 40, wherein the cross-linking agent is chosen from glycerin, triethanolamine and diethanolamine.

55. The process according to claim 40, wherein the blowing agent is chosen from lower alkanes, hydrofluorocarbons, perfluorocarbons and chlorofluorocarbons.

56. The process according to claim 40, wherein the blowing agent comprises liquid carbon dioxide and water.

57. The process according to claim 40, wherein the catalyst is chosen from stannous octoate, dibutyltin dilaurate, dibutyltin diacetate, bis(2-dimethyl-aminoethyl)ether, triethylene diamine and mixtures thereof.
